(19) United States
(12) Patent Application Publication
(10) Pub. No.: US 2021/0301553 A1
(43) Pub. Date: Sep. 30, 2021

(54) GUIDE-TYPE ACTUATOR ASSEMBLY

(71) Applicant: FIVETECH TECHNOLOGY INC., New Taipei City (TW)

(72) Inventor: TING-JUI WANG, New Taipei City (TW)

(21) Appl. No.: 17/183,367

(22) Filed: Feb. 24, 2021

(30) Foreign Application Priority Data
Mar. 26, 2020 (TW) 109203476

(51) Int. Cl. E05B 3/06

(52) U.S. Cl. CPC E05B 3/06

(57) ABSTRACT

A guide-type actuator assembly is disclosed, which includes a guiding actuator member having a body and at least one corresponding actuating section. The body is used to couple with a first object and cause a second object to move relative to the at least one corresponding actuating section. With these arrangements, at least two objects can be quickly connected together and easily disconnected from one another.

### CROSS-REFERENCE TO RELATED APPLICATION

This non-provisional application claims priority under 35 U.S.C. § 119(a) on Patent Application No(s).109203476 filed in Taiwan, R.O.C. on Mar. 26, 2020, the entire contents of which are hereby incorporated by reference.

### BACKGROUND OF THE INVENTION

### 1. Field of the Invention

The present disclosure relates to a handle, and in particular to a guide-type actuator assembly that enables at least two objects to be quickly connected together and easily disconnected from one another.

### 2. Description of the Related Art

Generally, when at least two objects are to be connected to one another, such as connecting a cover or a door to a box or a cabinet, screws are usually used to directly lock the at least two objects together. While the at least two objects can be connected together using screws, they could not be conveniently disconnected from one another because it is necessary to loosen the screws from the objects if any one of the objects is to be removed from other ones.

The above conventional fastening structure does not enable objects to be quickly connected together and easily disconnected from one another, and is not advantageous for competition in the market. It is therefore desirable to develop a guide-type actuator assembly that enables at least two objects to be quickly connected together and easily disconnected from one another.

### BRIEF SUMMARY OF THE INVENTION

In view of the disadvantage of the conventional fastening structure, it is an objective of the present disclosure to provide a guide-type actuator assembly for quickly connecting and easily disconnecting at least two objects to and from one another.

To achieve at least the above objective, the guide-type actuator assembly provided according to an embodiment of the present disclosure includes a guiding actuator member, which has a body portion and at least one corresponding actuating section. The body portion is used to couple with a first object and cause a second object to move relative to the corresponding actuating section.

The guide-type actuator assembly according to another embodiment of the present disclosure includes a guiding actuator member, which has a body portion, at least one corresponding actuating section, and a first locating element. The first locating element is provided on the body portion and is used to couple with a first object to cause a second object to move relative to the corresponding actuating section.

The guide-type actuator assembly according to a further embodiment of the present disclosure includes a guiding actuator member, which has a body portion, at least one corresponding actuating section, a first locating element, and a second locating element. The first locating element is provided on the body portion and is used to couple with a first object to cause a second object to move relative to the corresponding actuating section or the second locating element.

The guide-type actuator assembly according to a still further embodiment of the present disclosure includes a guiding actuator member and an actuated member. The guiding actuator member has a body portion and at least one corresponding actuating section; and the actuated member has at least one actuating section. The guiding actuator member and the actuated member mutually guide each other to move.

The guide-type actuator assembly according to another still further embodiment of the present disclosure includes a guiding actuator member, an actuated member and a base. The guiding actuator member has a body, at least one corresponding section and a first locating element; and the actuated member has at least one actuating section. The guiding actuator member and the actuated member mutually guide each other to move. The base has a first corresponding locating element, which is coupled with and located relative to the first locating element.

The guide-type actuator assembly according to another still further embodiment of the present disclosure includes a guiding actuator member, an actuated member and a base. The guiding actuator member has a body, at least one corresponding section, a first locating element and a second locating element; and the actuated member has at least one actuating section and a second corresponding locating element. The guiding actuator member and the actuated member mutually guide each other to move, while the second locating element and the second corresponding locating element are coupled with and located relative to each other. The base has a first corresponding locating element, which is coupled with and located relative to the first locating element.

In the above embodiments, the corresponding actuating section includes an expanded bore and a narrowed slot while the actuating section of the actuated member is correspondingly configured to include a head portion and a neck portion; or alternatively, the corresponding actuating section includes a head portion and a neck portion and the actuating section of the actuated member is correspondingly configured to include an expanded bore and a narrowed slot.

In an embodiment, the corresponding actuating section includes an expanded bore and a narrowed slot while the actuating section of the actuated member is correspondingly configured to include a head portion and a neck portion. The head portion of the actuating section has a size smaller than that of the expanded bore but larger than that of the narrowed slot, and the neck portion of the actuating section has a size smaller than that of the narrowed slot. Whereby, when the head portion is extended through the expanded bore, the neck portion can move into the narrowed slot while the head is held to below the narrowed slot.

In an embodiment, the corresponding actuating section includes a head portion and a neck portion while the actuating section of the actuated member is correspondingly configured to include an expanded bore and a narrowed slot. The head portion of the corresponding actuating section has a size smaller than that of the expanded bore but larger than that of the narrowed slot, and the neck of the corresponding actuating section has a size smaller than that of the narrowed slot. Whereby, when the head portion has been extended through the expanded bore, the neck portion can move into the narrowed slot while the head portion is held to above the narrowed slot.

In an embodiment, the second locating element of the guiding actuator member and the second corresponding locating element of the actuated member are coupled with each other to limit a range within which they can move relative to one another, and to allow the guiding actuator member and the actuated member to be movably actuated without separating from each other due to such a movement.

In the above embodiments, the second corresponding locating element and the second locating element can be coupled with and located relative to each other by way of riveting, fastening, screwing, expansion connection or welding.

In the above embodiments, the second corresponding locating element and the second locating element can be fixedly or movably coupled with and located relative to each other.

In an embodiment, the guiding actuator member and the actuated member are movably coupled with each other, and the first corresponding locating element of the base and the first locating element of the guiding actuator member are engaged with each other, such that the actuating section of the actuated member is movable in and relative to the corresponding actuating section of the guiding actuator member.

In the above embodiments, the guiding actuator member further includes a first handling section, at which a force can be applied to move the guiding actuator member; or alternatively, the actuated member includes a second handling section, at which a force can be applied to move the actuated member.

In an embodiment, the guiding actuator member includes a first handling section, which is pivotally movably connected to the guiding actuator member for bringing the guiding actuator member or the actuated member to move.

In an embodiment, the guiding actuator member includes a first handling section, which is pivotally movably connected to the guiding actuator member, and a second locating element, which is configured for engaging with the actuated member; whereby when the guiding actuator member and the actuated member are coupled with and located relative to each other, the first handling section can be operated to drive the guiding actuator member or the actuated member to move.

In the above embodiment, the second locating element of the guiding actuator member is pivotally connected to the guiding actuator member or pivotally connected to the first handling section.

In an embodiment, a movement space is existed at a pivotal point of the first handling section, the guiding actuator member or the second locating element of the guiding actuator member, allowing the first handling section, the guiding actuator member or the second locating element to move in the movement space.

In the above embodiments, the first handling section of the guiding actuator member is in the form of an operating lever, which can be operated by pushing and pulling it or can provide leverage when it is operated.

In the above embodiments, the first locating element of the guiding actuator member, the second locating element of the guiding actuator member, the second corresponding locating element of the actuated member or the first corresponding locating element of the base can be a through hole, a slot, a post, a guide slot, an elongated slot, a fastener, a protrusion, a recess or a stepped configuration.

In the above embodiments, the guiding actuator member has a body-defined space for receiving the first handling section of the guiding actuator member therein.

In the above embodiments, the actuated member is provided with an opening, and the body-defined space can be moved relative to and below the opening.

In the above embodiments, the first locating element of the guiding actuator member is coupled with and located relative to the first corresponding locating element of the base, such that the base does not move when the actuated member is moved relative to the corresponding actuating section of the guiding actuator member; and an assembled module of the actuated member and the guiding actuator member is removable from the base after the actuated member has been moved relative to the corresponding actuating section; and the assembled module of the actuated member and the guiding actuator member having been removed from the base can be connected to the base again simply by coupling the first locating element of the guiding actuator member with the first corresponding locating element of the base and then moving the actuated member to its original position on the guiding actuator member.

In the above embodiments, the first locating element of the guiding actuator member is coupled with and located relative to the first corresponding locating element of the base, such that the guiding actuator member and the base do not move when the actuating section of the actuated member is moved relative to the corresponding actuating section of the guiding actuator member.

In the above embodiments, the actuated member can be a cover or a door, and the base can be a box or a cabinet.

In an embodiment, the first handling section of the guiding actuator member includes a first pivotal connector or the second locating element of the guiding actuator member includes a second pivotal connector; the first and the second pivotal connector are respectively a shaft or a pin for pivotally connecting the first handling section and the second locating element, respectively, to the guiding actuator member; or in an alternative embodiment, the first and the second pivotal connector are integrally formed with the first handling section and the second locating element, respectively, or are integrally formed with the guiding actuator member.

In the above embodiments, the first locating element of the guiding actuator member is movably coupled with the first corresponding locating element of the base, such that the guiding actuator member is stopped from moving transversely relative to the base but is allowed to move longitudinally to separate from the base.

In an embodiment, a movement space is existed between the second locating element of the guiding actuator member and the second corresponding locating element of the actuated member, and the actuated member or the guiding actuator member are movable in the movement space.

In an embodiment, the guide-type actuator assembly further includes an operating section, which is pivotally movably connected to the guiding actuator member or the second locating element of the guiding actuator member via a third pivotal connector.

In an embodiment, the guide-type actuator assembly further includes an operating section, which can be rotationally operated to push or pull the actuated member or the first corresponding locating element of the base to thereby move the actuated member.

In an embodiment, the guide-type actuator assembly further includes an operating section, which can be operated by a force applied thereto to push or pull the actuated member, so as to move the actuated member.

In an embodiment, the guide-type actuator assembly further includes an operating section having a second push-pull portion, which can be rotationally operated to push or pull the actuated member, so as to move the actuated member.

In an embodiment, the guide-type actuator assembly further includes an operating section having a second push-pull portion, which can be operated to push or pull the actuated member, so as to move the actuated member.

With the above arrangements, the guide-type actuator assembly of the present disclosure enables at least two objects to be quickly connected together and be easily disconnected from one another.

### BRIEF DESCRIPTION OF THE DRAWINGS

FIG. 1 is an exploded perspective view of a guide-type actuator assembly according to a first preferred embodiment of the present disclosure.

FIG. 2 illustrates the manner of using the guide-type actuator assembly according to the first preferred embodiment of the present disclosure.

FIG. 3 is an exploded perspective view of a guide-type actuator assembly according to a second preferred embodiment of the present disclosure.

FIG. 4 illustrates the manner of using the guide-type actuator assembly according to the second preferred embodiment of the present disclosure.

FIG. 5 is an exploded perspective view of a guide-type actuator assembly according to a third preferred embodiment of the present disclosure.

FIG. 6 illustrates the manner of using the guide-type actuator assembly according to the third preferred embodiment of the present disclosure.

FIG. 7 illustrates the manner of using a guide-type actuator assembly according to a fourth preferred embodiment of the present disclosure.

### DETAILED DESCRIPTION OF THE INVENTION

To facilitate understanding of the objects, characteristics and effects of this present disclosure, embodiments together with the attached drawings for the detailed description of the present disclosure are provided. It is noted the present disclosure can be implemented or applied in other embodiments, and many changes and modifications in the described embodiments can be carried out without departing from the spirit of the disclosure, and it is also understood that the preferred embodiments are only illustrative and not intended to limit the present disclosure in any way.

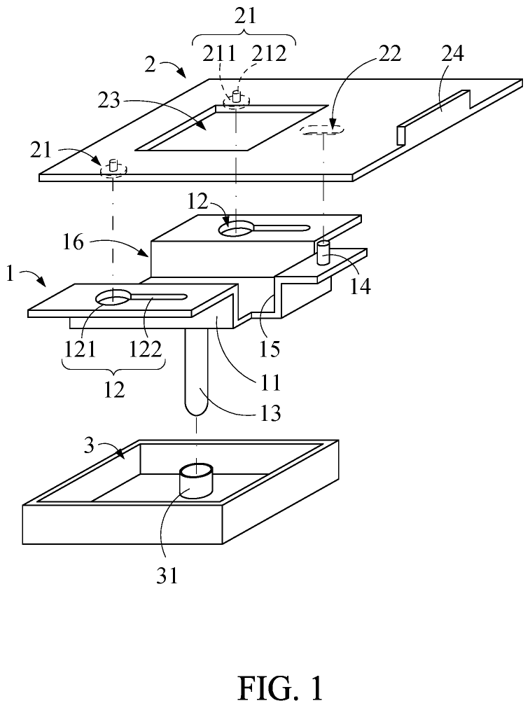

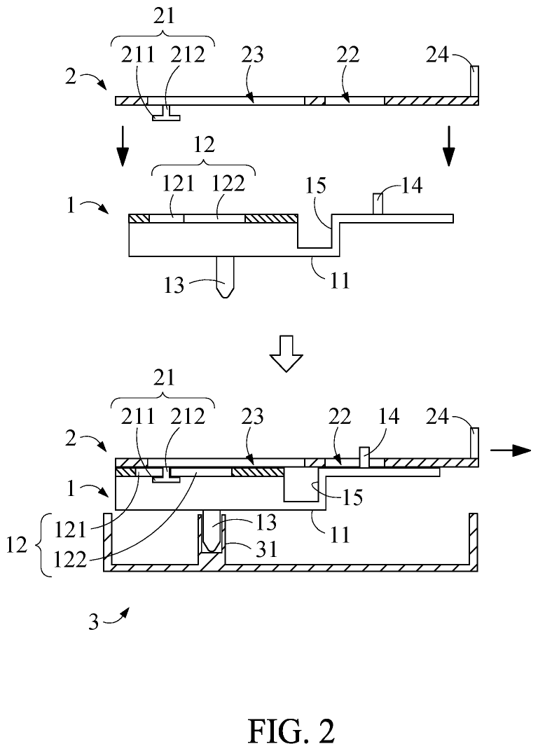

Please refer to FIGS. 1 and 2. A guide-type actuator assembly according to a first preferred embodiment of the present disclosure includes a guiding actuator member 1, which includes a body portion 11 and at least one corresponding actuating section 12. The body portion 11 is used to couple with a first object and cause a second object to move relative to the corresponding actuating section 12.

In the first preferred embodiment of the present disclosure, the guiding actuating member 1 further includes a first locating element 13 and a second locating element 14. The first locating element 13 is provided on the body portion 11 and is used to couple with a first object, such that a second object is movable relative to the corresponding actuating section 12 or the second locating element 14.

In the first preferred embodiment, the guide-type actuator assembly further includes an actuated member 2, which includes at least one actuating section 21. The guiding actuator member 1 and the actuated member 2 mutually guide each other to move. Wherein, the actuated member 2 can be the second object.

In the first preferred embodiment, the guide-type actuator assembly further includes a base 3, which can be the first object. The base 3 includes a first corresponding locating element 31. The first corresponding locating element 31 and the first locating element 13 are coupled with and located relative to each other.

In practical implementation of the present disclosure, the guide-type actuator assembly includes a guiding actuator member 1, an actuated member 2 and a base 3. Wherein, the guiding actuator member 1 includes a body portion 11, at least one corresponding actuating section 12, a first locating element 13 and a second locating element 14; and the actuated member 2 includes at least one actuating section 21 and a second corresponding locating element 22. The guiding actuator member 1 and the actuated member 2 mutually guide each other to move, and the second locating element 14 and the second corresponding locating element 22 are coupled with and located relative to each other. The base 3 includes a first corresponding locating element 31 coupled with the first locating element 13 to hold the base 3 and the guiding actuator member 1 together.

In the first preferred embodiment, the actuated member 2 can be a cover or a door, and the base 3 can be a box or a cabinet. In an example of application, the base 3 can be in a fixed and immovable state, the guiding actuator member 1 is connected to the base 3 by coupling the first locating element 13 of the guiding actuator member 1 with the first corresponding locating element 31 of the base 3, such that the first locating element 13 is longitudinally movably relative to and releasably from the base 3 but not transversely movable relative to the base 3. Then, the actuated member 2 is connected to the guiding actuator member 1 by coupling the second corresponding locating element 22 of the actuated member 2 with the second locating element 14 of the guiding actuator member 1, such that the second locating element 14 and the second corresponding locating element 22 mutually limit each other while allow the guiding actuator member 1 to actuate the actuated member 2 to move relative to it without separating therefrom during moving. Therefore, when the actuated member 2 is movably assembled to the guiding actuator member 1 while the latter is fixedly held to the base 3 through engagement of the first locating element 13 with the first corresponding locating element 31, the at least one actuating section 21 of the actuated member 2 can move in the at least one corresponding actuating section 12, allowing the actuated member 2 to move relative to the guiding actuator member 1. Since the guiding actuator member 1 is not transversely movable relative to the immovable base 3 through the engagement of the first locating element 13 with the first corresponding locating element 31, the base 3 does not move when the actuated member 2 is moved relative to the corresponding actuating section 12 of the guiding actuator member 1. Further, since the guiding actuator member 1 is longitudinally releasably from the immovable base 3, an assembled module of the actuated member 2 and the guiding actuator member 1 can be removed from the base 3 after the actuated member 2 has been moved relative to the corresponding actuating section to thereby easily disconnect the actuated member 2 from the base 3. To connect the actuated member 2 to the base 3 again, simply couple the first locating element 13 of the guiding actuator member 1 with the first corresponding locating element 31 of the base 3 and then move the actuated member 2 relative to the guiding actuator member 1 to its original position on the guiding actuator member. In this manner, at least two objects can be quickly connected together and easily disconnected from one another.

In the first preferred embodiment, the corresponding actuating section 12 includes an expanded bore 121 and a narrowed slot 122; and the actuating section 21 of the actuated member 2 includes a head portion 211 and a neck portion 212. The head portion 211 of the actuating section 21 has a size smaller than that of the expanded bore 121 but larger than that of the narrowed slot 122, and the neck portion 212 of the actuating section 21 has a size smaller than that of the narrowed slot 122. With these arrangements, after the head portion 211 is extended through the expanded bore 121, the neck portion 212 can be moved into the narrowed slot 122 while the head portion 211 is held to below the narrowed slot 122, allowing the actuating section 21 of the actuated member 2 to move in along the corresponding actuating section 12 of the guiding actuator member 1. In this manner, the guiding actuator member 1 can be operated to actuate the actuated member 2 to move relative to it without separating therefrom during the movement. Thus, at least two objects, i.e. the guiding actuator member 1, the actuated member 2 and the base 3, can be quickly connected together and easily disconnected from one another.

In the present disclosure, the second corresponding locating element 22 and the second locating element 14 can be located relative to each other and held together by way of riveting, fastening, screwing, expansion connection or welding, so that the second corresponding locating element 22 and the second locating element 14 can be fixedly or movably located relative to each other. In the illustrated first preferred embodiment, the second corresponding locating element 22 and the second locating element 14 are movably located relative to each other, allowing the present disclosure to be more practical for use.

In the first preferred embodiment, the guiding actuator member 1 includes a first handling section 15. The guiding actuator member 1 can be operated at the first handling section 15, allowing the present disclosure to be more practical for use.

In the first preferred embodiment, the guiding actuator member 1 has a body-defined space 16 for receiving the first handling section 15 therein, making the present disclosure more practical for use.

In the first preferred embodiment, the actuated member 2 is provided with an opening 23, and the body-defined space 16 can be moved relative to and below the opening 23, allowing the present disclosure to be more practical for use.

In the first preferred embodiment, the actuated member 2 includes a second handling section 24, and the actuated member 2 can be operated at the second handling section 24 to move. With this arrangement, the actuated member 2 can be easily operated.

In the first preferred embodiment, the first locating element 13 of the guiding actuator member 1, the second locating element 14 of the guiding actuator member 1, the second corresponding locating element 22 of the actuated member 2 or the first corresponding locating element 31 of the base 3 can be a through hole, a slot, a post, a guide slot, an elongated slot, a fastener, a protrusion, a recess or a stepped configuration, so that the present disclosure can be more practical for use.

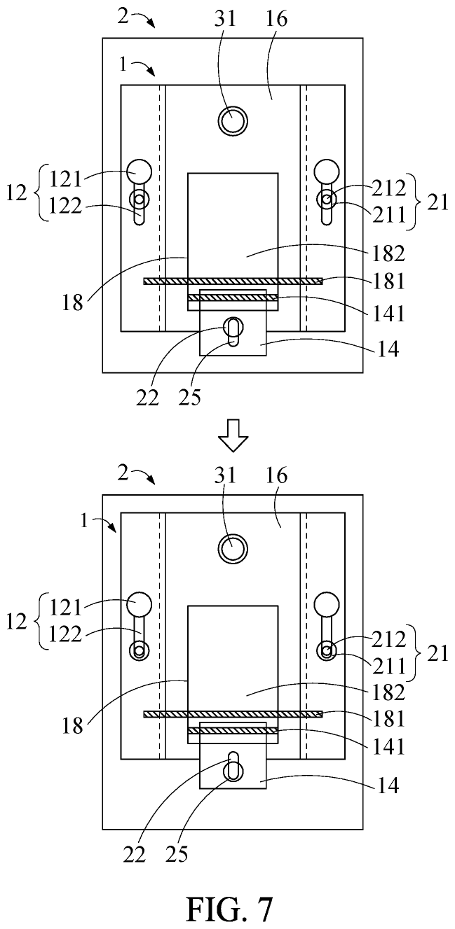

In an embodiment of the present disclosure as shown in FIG. 7, there is a movement space 25 existed between the second locating element 14 of the guiding actuator member 1 and the second corresponding locating element 22 of the actuated member 2. The movement space 25 provides a space for the actuated member 2 or the guiding actuating member 1 to move therein. With this arrangement, the present disclosure is more practical for use.

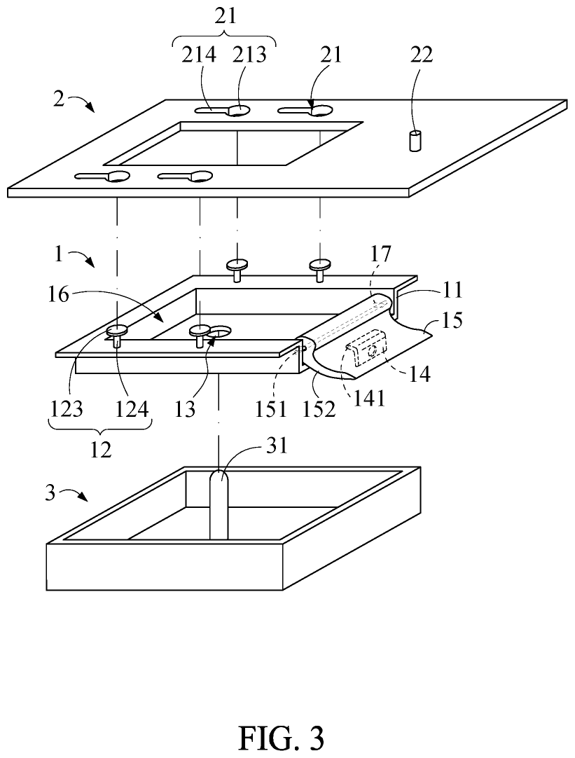

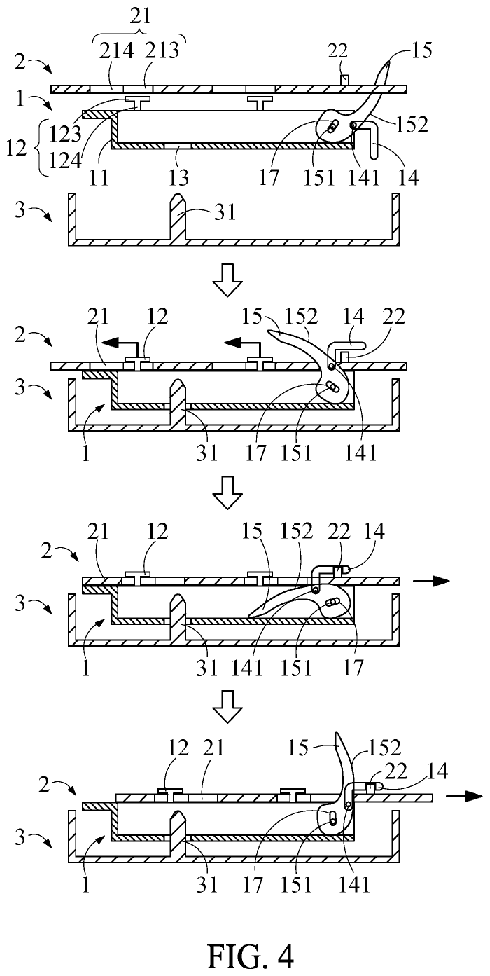

In FIGS. 3 and 4, there is shown a second preferred embodiment of the present disclosure. The second preferred embodiment is different from the first one in that the first handling section 15 thereof is configured for pivotally movably connected to the guiding actuator member 1 via a first pivotal connector 151, and that the second locating element 14 of the guiding actuator member 1 is pivotally movably connected to the first handling section 15 via a second pivotal connector 141. In the second preferred embodiment, the second locating element 14 of the guiding actuator member 1 is configured for engaging with the actuated member 2. When the actuated member 2 is coupled with the guiding actuator member 1 to be movably located relative to the latter, the first handling section 15 can be operated to drive the guiding actuator member 1 and the actuated member 2 to move.

In the second preferred embodiment, the corresponding actuating section 12 includes a head portion 123 and a neck portion 124, and the actuating section 21 of the actuated member 2 includes an expanded bore 213 and a narrowed slot 214. The head portion 123 of the corresponding actuating section 12 has a size smaller than that of the expanded bore 213 but larger than that of the narrowed slot 214, and the neck portion 124 of the corresponding actuating section 12 has a size smaller than that of the narrowed slot 214. With this arrangements, after the head portion 123 is extended through the expanded bore 213, the neck portion 124 can be moved into the narrowed slot 214 while the head portion 123 is held to above the narrowed slot 214, allowing the corresponding actuating section 12 of the guiding actuator member 1 to move in along the actuating section 21 of the actuated member 2. In this manner, the guiding actuator member 1 can be operated to actuate the actuated member 2 to move relative to it without separating therefrom during the movement. Thus, at least two objects, i.e. the guiding actuator member 1, the actuated member 2 and the base 3, can be quickly connected together and easily disconnected from one another.

In the second preferred embodiment, a movement space 17 is existed at a pivotal point of the first handling section 15, the guiding actuator member 1 or the second locating element 14 of the guiding actuator member 1, allowing the first handling section 15, the guiding actuator member 1 and the second locating element 14 to move in the movement space 17. Whereby, when the actuated member 2 and the guising actuating member 1 are coupled with and located relative to one another, the first handling section 15 can be operated to drive the guiding actuator member 1 and the actuated member 2 to move.

In the second preferred embodiment, the first handling section 15 of the guiding actuator member 1 can be an operating lever, which can be operated by pushing and pulling it or can provide leverage when it is operated, so that the guide-type actuator assembly of the present disclosure is easily operable in a labor-saving manner.

In the second preferred embodiment, the second corresponding locating element 22 and the second locating element 14 can be fixedly located relative to and engaged with one another, allowing the present disclosure to be more practical for use.

In the second preferred embodiment, the second pivotal connector 141 and the first pivotal connector 151 can be respectively a shaft or a pin for pivotally connecting the second locating element 14 and the first locating element 15, respectively, to the guiding actuator member 1. Alternatively, the second pivotal connector 141 and the first pivotal connector 151 can be integrally formed with the guiding actuator member 1, or be integrally formed with the second locating element 14 and the first handling section 15, respectively, so that the present disclosure is more practical for use.

In the second preferred embodiment, the first handling section includes a first push-pull portion 152.

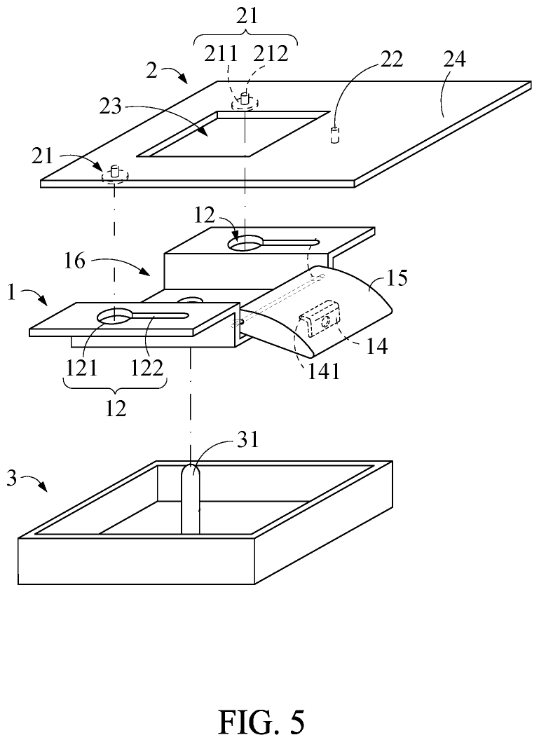

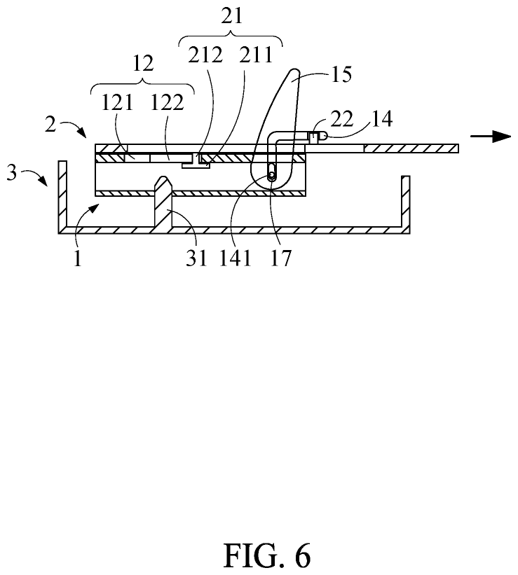

In FIGS. 5 and 6, there is shown a third preferred embodiment of the present disclosure. The third preferred embodiment is different from the first one in that the first handling section 15 thereof is configured for pivotally movably connected to the guiding actuator member 1 via a first pivotal connector 151, and that the second locating element 14 of the guiding actuator member 1 is also pivotally movably connected to the guiding actuator member 1 via a second pivotal connector 141. In the second preferred embodiment, the second locating element 14 of the guiding actuator member 1 is configured for engaging with the actuated member 2. When the actuated member 2 is coupled with the guiding actuator member 1 to be movably located relative to the latter, the first handling section 15 can be operated to drive the guiding actuator member 1 or the actuated member 2 to move.

As shown in FIG. 7, there is shown a fourth preferred embodiment of the present disclosure. The fourth preferred embodiment is different from the first one in that it further includes an operating section 18, which is pivotally movably connected to the guiding actuator member 1 or the second locating element 14 of the guiding actuator member 1 via a third pivotal connector 181. A user may apply a force at the operating section 18 to drive the actuated member 2 to move, bringing the actuating section 21 of the actuated member 2 to move in and relative to the corresponding actuating section 12 of the guiding actuator member 1. With these arrangements, at least two objects can be quickly connected together and be easily disconnected from one another.

In the fourth preferred embodiment, the operating section 18 includes a second push-pull portion 182. A user may apply a force at the second push-pull portion 182 of the operating section 18 to cause moving of the actuated member 2. With this arrangement, the present disclosure is more practical for use.

In a variant of the fourth preferred embodiment, the operating section 18 includes a second push-pull portion 182. A user may apply a force to rotate the operating section 18 for the latter to move rotationally, allowing the second push-pull portion 182 to move rotationally at the same time to thereby push or pull the actuated member 2 or the first corresponding locating element 31 of the base 3 and thereby move the actuated member 2. With this arrangement, the present disclosure is more practical for use.

While the present disclosure has been described by means of specific embodiments, numerous modifications and variations could be made thereto by those skilled in the art without departing from the scope and spirit of the present disclosure set forth in the claims.

What is claimed is:

1. A guide-type actuator assembly, comprising a guiding actuator member having a body portion and at least one corresponding actuating section; and the body portion being used to couple with a first object and cause a second object to move relative to the corresponding actuating section.

2. The guide-type actuator assembly according to claim 1, wherein the guiding actuator member further includes a first locating element; and the first locating element being provided on the body portion and being used to couple with the first object to cause the second object to move relative to the corresponding actuating section.

3. The guide-type actuator assembly according to claim 1, wherein the guiding actuator member further includes a first locating element and a second locating element; and the first locating element being used to couple with the first object to cause the second object to move relative to the corresponding actuating section or the second locating element.

4. The guide-type actuator assembly according to claim 1, further comprising an actuated member; the actuated member having at least one actuating section, and the guiding actuator member and the actuating section mutually guide each other to move.

5. A guide-type actuator assembly, comprising:
a guiding actuator member having a body portion, at least one corresponding actuating section and a first locating element;
an actuated member having at least one actuating section; and the guiding actuator member and the actuated member mutually guide each other to move; and
a base having a first corresponding locating element, which is coupled with and located relative to the first locating element.

6. The guide-type actuator assembly according to claim 5, wherein the guiding actuator member further includes a second locating element and the actuated member further includes a second corresponding locating element; and the second locating element and the second corresponding locating element being coupled with and located relative to each other.

7. The guide-type actuator assembly according to claim 1, wherein the corresponding actuating section is configured to include an expanded bore and a narrowed slot while the actuating section of the actuated member is correspondingly configured to include a head portion and a neck portion; and alternatively, the corresponding actuating section is configured to include a head portion and a neck portion while the actuating section of the actuated member is correspondingly configured to include an expanded bore and a narrowed slot.

8. The guide-type actuator assembly according to claim 5, wherein the corresponding actuating section is configured to include an expanded bore and a narrowed slot while the actuating section of the actuated member is correspondingly configured to include a head portion and a neck portion; and alternatively, the corresponding actuating section is configured to include a head portion and a neck portion while the actuating section of the actuated member is correspondingly configured to include an expanded bore and a narrowed slot.

9. The guide-type actuator assembly according to claim 1, wherein the corresponding actuating section is configured to include an expanded bore and a narrowed slot while the actuating section of the actuated member is correspondingly configured to include a head portion and a neck portion; and the head portion of the actuating section having a size smaller than that of the expanded bore but larger than that of the narrowed slot, and the neck of the actuating section having a size smaller than that of the narrowed slot; whereby when the head portion has been extended through the expanded bore, the neck portion can be moved into the narrowed slot while the head portion is held to below the narrowed slot.

10. The guide-type actuator assembly according to claim 5, wherein the corresponding actuating section is configured to include an expanded bore and a narrowed slot while the actuating section of the actuated member is correspondingly configured to include a head portion and a neck portion; and the head portion of the actuating section having a size smaller than that of the expanded bore but larger than that of the narrowed slot, and the neck of the actuating section having a size smaller than that of the narrowed slot; whereby when the head portion has been extended through the expanded bore, the neck portion can be moved into the narrowed slot while the head portion is held to below the narrowed slot.

11. The guide-type actuator assembly according to claim 1, wherein the corresponding actuating section is configured to include a head portion and a neck portion while the actuating section of the actuated member is correspondingly configured to include an expanded bore and a narrowed slot; and the head portion of the corresponding actuating section having a size smaller than that of the expanded bore but larger than that of the narrowed slot, and the neck of the corresponding actuating section having a size smaller than that of the narrowed slot; whereby when the head portion has been extended through the expanded bore, the neck portion can be moved into the narrowed slot while the head portion is held to above the narrowed slot.

12. The guide-type actuator assembly according to claim 5, wherein the corresponding actuating section is configured to include a head portion and a neck portion while the actuating section of the actuated member is correspondingly configured to include an expanded bore and a narrowed slot; and the head portion of the corresponding actuating section having a size smaller than that of the expanded bore but larger than that of the narrowed slot, and the neck of the corresponding actuating section having a size smaller than that of the narrowed slot; whereby when the head portion has been extended through the expanded bore, the neck portion can be moved into the narrowed slot while the head portion is held to above the narrowed slot.

13. The guide-type actuator assembly according to claim 1, wherein the second locating element of the guiding actuator member and the second corresponding locating element of the actuated member are coupled with each other to limit a range within which they can move relative to one another, such that the guiding actuator member and the actuated member can be mutually movably actuated without separating from each other due to such a movement.

14. The guide-type actuator assembly according to claim 5, wherein the second locating element of the guiding actuator member and the second corresponding locating element of the actuated member are coupled with each other to limit a range within which they can move relative to one another, such that the guiding actuator member and the actuated member can be mutually movably actuated without separating from each other due to such a movement.

15. The guide-type actuator assembly according to claim 1, wherein the guiding actuator member and the actuated member are movably coupled with each other, and the first corresponding locating element of the base is engaged with the first locating element of the guiding actuator member, such that the actuating section of the actuated member is movable in and relative to the corresponding actuating section of the guiding actuator member.

16. The guide-type actuator assembly according to claim 5, wherein the guiding actuator member and the actuated member are movably coupled with each other, and the first corresponding locating element of the base is engaged with the first locating element of the guiding actuator member, such that the actuating section of the actuated member is movable in and relative to the corresponding actuating section of the guiding actuator member.

17. The guide-type actuator assembly according to claim 1, wherein the guiding actuator member and the actuated member are movably coupled with each other, and the first corresponding locating element of the base is engaged with the first locating element of the guiding actuator member, such that the actuating section of the actuated member is movable in and relative to the corresponding actuating section of the guiding actuator member.

18. The guide-type actuator assembly according to claim 5, wherein the guiding actuator member includes a first handling section, at which a force can be applied to move the guiding actuator member; or wherein the actuated member includes a second handling section, at which a force can be applied to move the actuated member.
